(19) United States
(12) Patent Application Publication
(10) Pub. No.: US 2011/0202454 A1
(43) Pub. Date: Aug. 18, 2011

(54) METHOD AND SYSTEM FOR MANAGING RESOURCES

(75) Inventor: Kirill Ilinski, Grays (GB)

(73) Assignee: FUSION INVESTMENT ADVISERS LIMITED, George Town (GB)

(21) Appl. No.: 13/025,910

(22) Filed: Feb. 11, 2011

Related U.S. Application Data
(60) Provisional application No. 61/303,397, filed on Feb. 11, 2010.

(51) Int. Cl. G06Q 40/00

(52) U.S. Cl. 705/39

(57) ABSTRACT

A method of managing resources through optimising performance-based compensation is presented. The method is particularly applicable to fund management, and can provide a number of advantages in fund management including: asymmetric recourse against a fund manager's compensation, dynamically managed exposure and performance fees varied according to an agreement between an investor and the manager. The method comprises monitoring the value of the fund, calculating a performance fee that is due to the fund manager for managing the fund, adding, when the value of the fund increases, a first portion of the performance fee to a fund manager's account, and a second portion of the performance fee to a cushion account, and subtracting, when the value of the managed fund decreases over said time period, a compensation fee from the cushion account to compensate for at least some of the decreased value of the managed fund.

### CROSS-REFERENCE TO RELATED APPLICATIONS

This application claims the benefit of U.S. Provisional Patent Application No. 61/303,397 the contents of which is incorporated herein by reference.

### FIELD OF THE INVENTION

The present invention relates to methods and systems for managing resources. In particular, the present invention relates to methods and systems for managing resources to minimise the effects of volatility in the value and/or availability of those resources. As such, the present invention may also relate to methods and systems for stabilizing the value of a resource that is managed by a manager.

Even more specifically, the present invention relates to methods and systems for controlling the management of a fund. The present invention is particularly applicable in managing financial resources to smoothen the effects of volatile markets on such resources but it will be understood that it can also be applied to other situations. For example, the invention can be applied to control performance related payment—such as bonuses—where performance is measured against a volatile metric. Furthermore, the invention also has applicability in the management of energy resources, for example, where the supply of electrical energy is subject to uncontrollable factors and so is unreliable or volatile in nature.

While the present invention can be applied to many different scenarios, in the interests of brevity, it will primarily be described in relation to its applicability to the finance industry.

### BACKGROUND AND DISCUSSION OF PRIOR ART

The finance industry encompasses a broad range of organisations that deal with management of money: Among these organizations are banks, credit card companies, insurance companies, consumer finance companies, stock brokers, investment funds and some government sponsored enterprises. The finance industry currently represents 15% of the market capitalization of Standard and Poor's (S&P) 500 index in the United States.

Investment management (or asset management) is the professional management of various securities (shares, bonds etc.) and assets (e.g., real estate) to meet specified investment goals for the benefit of investors. Investors may be institutions (insurance companies, pension funds, corporations etc.) or private investors (both directly via investment contracts and more commonly via collective investment schemes).

The term asset management is often used to refer to the investment management of collective investments, while the more generic fund management may refer to all forms of institutional investment as well as investment management for private investors. Investment managers who specialize in advisory or discretionary management on behalf of (normally wealthy) private investors may often refer to their services as wealth management or portfolio management often within the context of so-called “private banking”.

A collective investment scheme is a way of investing money with others to participate in a wider range of investments than feasible for most individual investors, and to share the costs and benefits of doing so.

Collective investment schemes are often referred to as mutual funds, investment funds, managed funds, or simply funds. Around the world large markets have developed around collective investment and these account for a substantial portion of all trading on major stock exchanges.

Collective investments are promoted with a wide range of investment aims either targeting specific geographic regions (e.g. Emerging Europe) or specified themes (e.g. technology).

A ‘collective investment scheme’ product (Fund Product) has the following elements:
investment objective
investment strategy
investment restrictions
liquidity characteristics
risk profile
manager
fee structure

The typical investment characteristics of a Fund Product are:
return
volatility
Sharpe ratio
maximal drawdown

Funds are often selected for investment on the basis of the investment characteristics, taking into account the abovementioned elements and considering their past investment performance.

Generally, investors invest money into funds, which are managed by managers as part of a service to the investors.

The service tends to be paid for by the investors via the manager earning:
a) a predetermined/constant “management fee” calculated by reference to the assets in the fund regardless of performance of the fund; and
b) a variable “performance fee” which is linked to the performance (growth) of the fund.
   This fee may be seen as a ‘slice of the profits’ made on the fund for any given performance period.

While the amounts for these fees can be individually agreed, they tend to be around 2% per annum management fee and a 20% of fund profit performance fee.

The manager tends not to be encouraged by the performance fee arrangement to take a conservative approach that will yield steady long-term profits for the fund. This is because the performance fee is determined on each individual time period (typically quarterly) independently of the performance in other time periods.

This performance fee arrangement tends to encourage the manager to take excessive risks in an attempt to reap greater profits for the fund. If the risk is successful, then the fund manager will benefit from the resulting high performance fees for a given time period. If the risk is unsuccessful, then the fund manager simply gets no performance fee, even if the investor has suffered loss on the fund for a given period. Thus over a longer series of time periods the profit may be negative (namely a negative overall performance), but the manager has been paid for a particular period in which the performance was good. Thus, for a fund with poor overall fund performance with a high volatility, this will result in the manager being unfairly rewarded with some performance fees.

Some arrangements exist in the prior art in an attempt to overcome the above disadvantages which are discussed below.

### The “Claw Back” Fee Arrangement

The “claw back” fees arrangement is implemented typically where the investment cannot be redeemed for long periods (e.g. 2-3 years set as a “lock up period”). The performance period is shorter than the lock up period (e.g. 1 year) and longer than period of Net Asset Value calculation.

This type of fee arrangement is common in private equity or distressed debt funds, and also in fund restructuring scenarios. This type of fee arrangement is designed to mitigate the discrepancy between unrealised gains (on which performance fees are calculated at the end of the performance period and paid in part to the manager) and realised gains (when investor can exit).

The claw back fees operate as follows:
At the end of the performance period, a portion (typically a third or a quarter) of the customary performance fees (e.g. 10%-20% of the profits) are paid into an escrow account or reinvested into the fund. This is known as a balancing payment.
Effectively, at the end of the performance period, the manager receives a third to a quarter advance of his “unrealised gains” performance fees before “realised gains” are determined at the end of the lock up period;
At the end of the lock up period, the performance (“realised gains”) is recalculated between launch and end of the lock up period (the performance period is replaced with the lock up period). The adjustment is made to performance fees (by way of withholding if necessary the balancing payment) to reflect realised gains.

However, this fee arrangement is disadvantageous because the compensation available to the investor is not asymmetrical to what the manager gains as performance fees. The manager gives “clawback” against performance fees over the lock up period, but only proportionately to what the manager gains as performance fees (at the end of the lock up period), such performance fees adjusted to reflect the realised (as opposed to unrealised) gain. Thus the manager is still encouraged to take risk over at least part of the lock up period.

Furthermore, with this fee arrangement, the performance period is not always aligned with the period for calculating net asset value. This results in volatility spikes of the trading performance.

U.S. Pat. No. 7,624,059

Patent publication number: U.S. Pat. No. 7,624,059, the content of which is hereby incorporated by reference, describes the Pre-Funded Accrual Account (PFAA) arrangement.

The balance of the PFAA is only utilized to provide compensation of trading losses on fixed size investment. There is no dynamic change in the exposure of the related fund depending on the accumulated fees. Therefore, the investor benefit from the cash that the manager is storing away is limited to the scenarios when the fund is losing money.

The PFAA utilises a high watermark (i.e. the maximum value of PFAA of the previous period)—“Concept of Accrual Recapture”, column 3, lines 45 to 50. If the PFAA balance drops below the PFAA high watermark, the contribution to PFAA is funded from the performance of the fund, until the PFAA balance is higher than PFAA high watermark. Once the PFAA balance is higher than the PFAA high watermark, the contribution to PFAA is funded by the performance fees (rather than the performance of the fund).

This means that the protection available to the investor from PFAA is limited (the high watermark protection is financed by the investors performance not the performance fees), and asymmetric only where the PFAA is above the high watermark. It also gives investor incentives to redeem after the drawdown covered by the PFAA as the first performance will be allocated to the PFAA.

Therefore, as with the “clawback” fee arrangement, the compensation available to the investor is not asymmetrical to what the manager gains as performance fees.

Furthermore, the use of a PFAA means that there is no mechanism to pre-fund PFAA (i.e. before there are any performance fees for the manager to start paying in).

It is an object of the present invention to overcome the above-mentioned problems, at least in part.

### SUMMARY OF THE INVENTION

According to one aspect of the present invention there is provided a method of managing resources. The method may minimise the effects of volatility in the value and/or availability of resources. The method may also relate to stabilizing the value of a resource that is managed by a manager. It will be appreciated that the terms “resources” and “resource” are interchangeable herein and may refer to one or more different types of resources.

The resource may be in the form of an asset having a notional monetary value. For example, the resource may be in the form of a fund, the share price of a company, an investment, or any other financial asset.

A resource or investment may also be referred to as a return generator. The term investment may include a single investment or a plurality of investments. Investments may include or relate to cash, liquid assets, illiquid assets (pledged or otherwise collaterised), credit and/or a general obligation of the investor. Investments may be standalone investment structures. Investments or investment products may have a benchmark, a hurdle, and may include tracker funds or absolute return funds.

In alternatives, the resource may in another quantifiable form. For example, instead of monetary value, the resource could be measured by another metric. For example, where the resource is energy, the resource may be electrical energy.

The invention provides for the resource to be fungible. In particular, the invention provides for the resource to be transferable, or at least exchangeable between different resource stores. For example, where the resource is a financial asset, the value of that asset may be transferable between different financial accounts. Where the resource is energy, the resource may be transferable between different energy stores, for example, an electrical storage system and a mechanical storage system.

The invention provides for a manager to manage the resource. The term manager may include an individual person, a group or team of individuals, a company or group of companies and/or a computer system programmed and arranged to manage the resources. The manager may be a fund manager. The manager may be a member of bank personnel who makes an investment decision on behalf of that bank or a unit of a bank. Where a computer system is utilized to manage resources, the computer system may comprise artificial intelligence, neural networks and/or other data processing functions for the purposes of managing a resource.

The invention also provides for the manager to be rewarded or otherwise compensated for managing the resource. Management, in this context, may include attempting to create value on investments through financial relations which, in whole or in part, utilise performance or incentive-based compensation.

The manager may have an account into which rewards are deposited. The method may comprise controlling the reward provided to the manager to incentivize responsible management of the resource. The reward may be provided in the form of a performance fees, or at least a portion of performance fee.

The method may comprise using a computer system. The computer system may be a single computer, or a collection of computers interconnected by one or more networks—for example, a LAN (local area network), a wireless network, a WAN (Wide Area Network) and/or the global Internet. The computer system may comprise a handheld/portable device such as a mobile handset or a PDA.

The computer system may be set up as a client-server model, a cloud computing model or any infrastructure apparent to those skilled in the art. Clients may be provided for involved parties to interface with the computer system (for example, a client for the fund manager and a client for the investor).

The computer system may be used to perform calculations of the method. The computer system may be used to store information relating the method—for example, amounts stored in accounts. The computer system may be used to make or determine payments to and/or transfer amounts between accounts. Furthermore, the computer system may monitor the value of a resource. The computer system may have redundancy, authorisation, authentication and/or encryption modules for maintaining the integrity of data stored and/or transmitted. Such modules may be implemented in software or hardware. It will be appreciated that one or more steps of the method may be implemented using a computer system.

Where the method comprises managing resources in the form of a fund, the method may comprise monitoring the value of the fund. The monitoring step may be performed over a time period. The time period may be a performance assessment period, or ‘performance period’. The method may comprise calculating a performance fee that is due to the fund manager for managing the fund for said time period.

The method may comprise adding a first portion of the performance fee to a fund manager's account and a second portion of the performance fee to a cushion account. Said adding step may be executed only when the value of the fund increases over said time period.

It will be understood that the fund manager's account and the cushion account are ideally separate from one another. Furthermore, the cushion account is ideally outside of the control or influence of the fund manager.

Ideally, the cushion account is separate from the fund (and its balance does not count towards the performance of the fund). Furthermore, the cushion account is controlled by a trusted third party and not by the manager. It will be understood that the cushion account can be advantageous to the fund as well as the manager. The fund benefits from reduced volatility whilst the manager can benefit from being the ultimate beneficiary of funds within this cushion account. In particular, amounts from the cushion account may be released to the manager once certain release conditions exist. Such release conditions may be related to the balance of the cushion account.

The adding step may comprise varying the amount of at least one of the first and second portion of the performance fees in accordance with the value of the cushion account.

The method may comprise subtracting a compensation fee from the cushion account. The subtracting may be executed when the value of the managed fund decreases over said time period, and the subtracted compensation fee may be used to compensate for at least some of the decreased value of the managed fund. For example, the amount subtracted from the cushion account may be added to the fund to stabilise its value.

The method may comprise repeating said steps of monitoring, calculating, adding and subtracting over multiple time periods. The repeating step can maximize the stabilizing potential of the cushion account and reduce the volatility of the fund value. The repeating step can also minimise the maximum drawdown of the fund.

The method can provide consecutive time periods of increasing fund value to increase the amount added to the cushion account asymmetrically to the amount added to the fund manager's account. Thus the cushion account provides a manager with a way of insuring against a larger percentage of loss than the manager receives in gains.

As mentioned, the computer system may be used to execute at least one of the monitoring, calculating, adding, subtracting and repeating steps.

The method may comprise the step of setting at least one threshold value against which the value of the fund is compared. The difference between the threshold value and the fund value may be used to control the size of the first portion. The difference between the threshold value and the fund value may be used to control the size of the second portion. The threshold value may be a high water-mark, and if the value of the fund is below said high water-mark, then the size of the first portion of the calculated performance fees is zero.

In a simple performance fee arrangement, the manager and investor may agree that the manager will not be entitled to receive performance fees until the value of the investment is beyond a “high water-mark”. This way, the losses of preceding performance periods must be recouped before the manager receives any portion of the performance fees. In alternatives, the portion of the performance fees that a manager receives may be restricted until the value of the investment is above the high water-mark. A fund stakeholder may be able to select whether or not a high water-mark is to be applied to his investment in the fund.

If cushion account is above a predetermined value this can affect the portion of the performance fees paid into the cushion account and portion paid to the fund manager's account.

The method may further comprising the step of setting at least one threshold value against which the value of the fund is compared. The difference between the threshold value and the fund value can thus be used to control the calculation of the size of the performance fee. The difference between the threshold value and the fund value can also be used to control at least one of the sizes of the first and second portions.

The method may further comprise the step of setting at least one predetermined value against which the value of the cushion account is compared. The difference between the predetermined value and the cushion account value can therefore be used to control the calculation of at least one of the size of the performance fee, the first portion and the second portion.

Thus, it will be appreciated that the method can allow the performance fees to be calculated and apportioned between the cushion account and/or the fund manager's account even when a fund is performing below a high water-mark (or threshold value). However, it will be appreciated that as the cushion account balance can be used to compensate the funds losses, the fund value is more likely to be at the or above the high water-mark.

The proportion of the performance fees transferred into the cushion account can be varied according to the fund value compared against the high water-mark. For example, the proportion of the performance fees transferred into the cushion account can be higher when the fund value is above the high water-mark by an amount double the proportion transferred when the fund value is below the high water-mark. For example, this could be an analogue of traditional performance fee structures—i.e. 40% high, 20% low on every Net Asset Value calculation period.

The inventors of the present invention have conducted risk return simulations that show that in certain circumstances the absence of a high water-mark leads to the cushion account being built up more quickly. As such, under certain circumstances, it may be advantageous for the overall performance of the fund not to utilise a high water mark.

The method may comprise a step of defining at least one parameter for controlling the computer system. Said at least one parameter may be for calculating the performance fee that is due to the fund manager for managing the managed fund. Said at least one parameter may be for determining the size of at least one of the first and second portions of the performance fee. Said at least one parameter comprises at least one of: Downside Protection, Equalization Reserve, Manager Account, Performance Fees, Manager Direct Payment, Performance Period, Reserve Value, Reserve Contribution, SAF Account, High Water-Mark level and Exposure.

The method may comprise authorizing an agreement between a fund stakeholder and the fund manager; the agreement including the definition of said at least one parameter.

The method of may further comprise at least one of the steps of:

communicating a set of parameters between a fund stakeholder and a fund manager;

receiving agreement from the fund stakeholder and the fund manager on the set of parameters;

receiving funds from the fund stakeholder into the fund to be managed by the fund manager; and

enabling control of the fund to the fund manager.

The computer system may be used to perform, assist with and/or authenticate any one of the communicating, receiving agreement, receive funds and/or enabling control steps. For example, the computer system may be a trusted intermediary system between a fund stakeholder and a fund manager. As such, a contract of agreement may be formed by the computer system between the fund stakeholder and the fund manager. The contract of agreement may comprise the set of parameters with which the computer system may execute the steps of the method. The computer system may be operated under control of a trust company, acting as an intermediary between a fund stakeholder and a fund manager.

It will be appreciated that the term “fund stakeholder” may be a reference to an investor of the fund.

The method may comprise the step of controlling the exposure of the managed fund. The exposure may be controlled in response to the amount available within the cushion account. As such, the amount of protected exposure can be linked to fees already accumulated. Thus, the method may comprise controlling the exposure dynamically in proportion to the amount available within the cushion account. Controlling the exposure may comprise authorising the fund manager to change the exposure of the managed fund.

The method may comprise the fund stakeholder and/or the fund manger paying a licence to a licence-holder. The licence-holder may hold the rights to the presently described invention. The trust company may be the licence-holder.

The method may further comprise the step of receiving an initial contribution to the cushion account. A fund manager may provide the initial contribution. For example a fund manager may provide an initial contribution by making an initial subscription to the fund. The subscription may include an undertaking to make a minimal initial subscription (with a corresponding initial contribution to the cushion account).

The method may further comprise the step of receiving a contribution to the cushion account for a fund investor entering into the fund at a subsequent date to equalise that investors' protection with the already accumulated balance of the cushion account. The said contribution can be made through transferring a certain portion of the subsequent investment into the cushion account as equalization reserve, which is returned to the investor at the time of his redemption, and the remaining portion of the said investment added to the capital of the fund.

The method may comprise the step of transferring at least a portion of the value of the cushion account to the fund manager's account in the event that the management of the managed fund is relinquished from the fund manager. This can incentivize the fund manager to manage the fund in a way maximising cushion account growth. This can also incentivize a fund stakeholder to continue using a well-performing fund manager to manage the fund.

The invention can thus provide a mechanism for performance-based compensation. This mechanism can remove the inherent conflict of interest between fund stakeholders and fund managers. Furthermore, the mechanism improves the quality of investment products.

The removal of conflict of interest may be thought of as aligning the interests of, and providing associated benefits for both a fund stakeholder and a fund manager. In particular, the invention can benefit a fund stakeholder as the risk-minimising characteristics of the cushion account can create significant improvements in the statistics of investment returns—including downside volatility, maximal drawdown, as well as Sharpe and Sortino Ratios.

The invention can also benefit a fund manager as it increases the stability of an investment base, creating an effective way of raising assets under management and earning higher overall fees in performing strategies. By arranging the manager compensation scheme by applying the method there is resulting negative incentive to an investor redeeming from a performing manager as doing so will result in the investor foregoes the protection to his investment built up through the accumulated balance of the cushion account, this can suppress yield chasing, breaking down the first link in the chain of self-reinforcing herding and financial instability.

The invention can also remove the problem known in the art as ‘the free call’. This problem relates to the fund manager unilaterally increasing the volatility of an asset or fund to maximise the potential performance fee payout to the fund manager. Whilst fund stakeholders may not necessarily mind volatility in itself, they do mind that fund managers are better protected than the fund stakeholders. Thus, to balance the situation, the method may require the fund manager to sell optionality back to the fund stakeholder. There is an argument to say that a fund manager should sell some of the downside protection back to investors. This type of performance fees structure could improve risk-return profiles for investors.

Furthermore, there is an argument to say that investors and managers should be ‘in the same ‘boat’—in that the manager should suffer explicit losses on the same scale as the manager benefits from gains.

It will be appreciated that the method is applicable to other scenarios, other than the management of funds, and the reward of fund managers.

For example, the method is applicable to the operation of banks. By way of background, banks provide various services mainly by accepting deposits and channelling those deposits into lending activities, either directly or through capital markets. Bank personnel who make investment decisions often receive part or all of their remuneration on the basis of performance achieved by their profit centre at the bank—usually a business unit or trading desk—within a specified time period.

As such, the principles of the present method are also applicable to banks. A person skilled in the art will realise that although the majority of the terms used herein focus on fund management, the method can be used to control the performance-related pay of bankers or other managers being rewarded via a performance-based model.

Furthermore, the method can be applied to various types of relationships in which performance based reward may be utilized. For example, such relationships may include relationships between managers and investors, between trading desks and the larger organization in which the trading desks are based, and/or relationships between executives and an associated enterprise managed by said executives.

It will also be appreciated that within a bank (and also potentially within an asset management firm) there will be several separate cushion account structures for each profit centre (or fund). Therefore, the remuneration of personnel is directly linked to the performance of their business unit only (and not the entire bank or firm). Remuneration can be made through equity in the operator of the cushion account rather than cash, so there are possible tax benefits inherent in the scheme as well, as fees paid can be a capital gain rather than income.

To clarify the applicability to banks, it will be appreciated by a person skilled in the art that suitable terms or functions may be substituted. For example, in cases where the term “manager” is used within this document to describe personnel making investment decisions for a fund, this can equally be applied to an employee, or group of employees within a bank. In cases where the term “investor” or “fund stakeholder” is used herein—for example, to describe a party who has allocated capital to a particular fund, this can equally be applied to shareholders of a bank.

Further features of the present method will also be apparent to a person skilled in the art. In particular, the method can be used to encourage wider economic benefits.

For example, if the method is implemented widely throughout the financial services industry, it can bring significant benefits for the broader economy. The method removes the incentive to herd into short-term yield-enhancing scenarios so, as the new fee structure is adopted across the industry, systemic risk will also be reduced. Investments currently viewed as “risky” will be de-risked once they implement the present method and, hence, they will attract more capital. Risk-averse investors, such as pension funds for example, will start rebalancing their allocations away from low-yielding assets into more productive instruments, providing a significant boost to economic growth and GDP.

Thus, the method can potentially also act to protect the global financial system from irresponsible short-term management, and generally bring social and economic benefits. In particular, the reduction of conflicts of interest between investors and managers can create an incentive for widespread responsible money management. This can lead to wider participation of non-professional participants in financial markets, increasing investment and global economic growth.

It will also be understood that the invention relates to a performance-based compensation method. In particular a responsible compensation structure is provided. This is described in greater detail in “Working paper FAM-02-10—Responsible Compensation Structure: Shock Absorber Fees” published by the present inventor at: http://www.fusionam.com/_upload/editor_files/Papers/SAFe.pdf, the contents of which are hereby incorporated by reference.

According to another aspect of the present invention, there may be provided a method of managing resources comprising:

communicating, using a computer system, a set of parameters between a resource provider and a resource manager;

receiving agreement from the resource provider and resource manager on the set of parameters, authenticated by the computer system;

receiving resources from the resource provider into a resource reserve to be managed by the resource manager;

enabling control, using the computer system, of the resource reserve to the resource manager;

apportioning, using a computer system, additional resources generated from the resource reserve after a period of management by the resource manager between the resource manager, the resource reserve and a resource store separate from the resource reserve; and

supplementing, after subsequent periods of management by the resource manager, the resource reserve from the separate resource store if additional resources are not sufficiently generated.

Advantageously, through storing a portion of the additional resources generated in a separate resource store, extraneous factors which may adversely affect the management and resource generation in subsequent periods of management can be offset by the resources available via the resource store which is separate from the resource reserve, and so unaffected by those extraneous factors. It will be understood that the separate resource store is not under the control of the resource manager and so is shielded from any adverse affects resulting from the activity of the resource manager. It will also be understood that it is beneficial not to keep all of the resources in the resource store, as it is not possible to manage the resource store to generate additional resources via the resource store.

The apportioning of additional resources may be modified once the resources in the separate resource store have reached a threshold limit.

According to yet a further aspect of the present invention, there may be provided a method of stabilizing the value of an resource that is managed by an resource manager on the behalf of a stakeholder, the method comprising:

monitoring the value of the resource, using a computer system, over a time period;

calculating, using the computer system, a performance fee that is due to the resource manager for managing the resource for said time period;

adding, when the value of the resource increases over said time period, a first portion of the performance fee to an resource manager's account, and a second portion of the performance fee to a cushion account, said adding being performed by the computer system;

subtracting, when the value of the managed resource decreases over said time period, a compensation fee from the cushion account to compensate the stakeholder for at least some of the decreased value of the managed resource, said subtracting being performed by the computer system;

repeating said steps of monitoring, calculating, adding and subtracting over multiple time periods to maximize the stabilizing potential of the cushion account and to reduce the volatility of the resource value; wherein consecutive time periods of increasing resource value increases the amount added to the cushion account asymmetrically to the amount added to an resource manager's account.

According to yet another aspect the present invention there may be provided a method of controlling the management of a fund, the method comprising:

determining the performance of a managed fund over a given time period and the associated performance fees due to a fund manager;

when there is profit/positive growth of the fund over that given period:
providing a portion of the performance fund management fees to the fund manager for the given time period, and
transferring another portion of the performance fund management fees into a cushion account,
and

when there is loss/negative growth of the fund over a subsequent period:
using the funds in the cushion account to compensate at least some of the loss/negative growth of that fund, thereby reducing the volatility of the fund value over time,
wherein the amount transferred to the cushion account is arranged to be built up over a series of consecutive periods to provide compensation asymmetrical to the performance fees in the event of negative growth of the fund in a subsequent period.

Advantageously, the cushion account maximises the ability of an investor to be compensated for negative growth of a fund as the cushion account is built up over time. This results in a source of compensation being created which is completely asymmetric to that which a manager gains in terms of performance fees. This is because, every time, an agreed portion of the performance fees fills the cushion account.

In other words, the cushion account provides insurance for an investor that is disassociated from the performance fee earned by a manager over any time period, or limited series of time period. Instead, the insurance is established over the lifetime of the established association between the fund and the manager. Another way of viewing this advantage is by considering the fact that the size of a fund will grow over time. Because the cushion account also grows over the same period, the downturn protection over the lifetime of the fund is maintained.

A further advantage is that the net asset value of the fund is therefore calculated in alignment with the time period over which performance is assessed. Accordingly, this mitigates volatility spikes of the trading performance.

The method may comprise controlling the exposure of the managed fund in response to the size of the funds available in the cushion account. The controlling of the exposure may comprise increasing the exposure when the funds available in the cushion account increase. The controlling of the exposure may comprise decreasing the exposure when the funds available in the cushion account decrease. The controlling of the exposure may comprise the step of signalling and/or sending an authorisation to the fund manager to change the exposure of the managed fund.

Advantageously, this provides an investor with the ability to take advantage of the increasing balance of the cushion account. As the level of downturn protection is increased the investor can have the exposure changed dynamically in response to the changing balance of the cushion account—authorising the manager to change the risk profile of the fund, usually to make it more risky for the chance of reaping greater rewards. Conversely, if the amount in the cushion account is decreased as a result of the fund accruing losses, then the risk profile can be dynamically changed to make it less risky (as a result of there being a lower amount in the cushion account—and so less downturn protection in the event that a risky decision doesn't pay off).

The method may comprise the step of receiving from a fund manager, an initial contribution to the cushion account. Advantageously, this provides a mechanism to provide initial funding of the cushion account.

The method may comprise the step of contributing a portion of subscription by the investor into the cushion account proportionately to the already accumulated balance of the cushion account

The value of the cushion account may be dependent on the performance of a plurality of periods preceding the given period.

The portion of the performance fees transferred into the cushion account may be varied according to the value of the cushion account.

The proportion of the performance fees transferred into the cushion account may be reduced as the value of the cushion account increases.

The method may comprise determining how much of any loss/negative performance is to be compensated by the funds in the cushion account and using this determined amount in the transferring step.

The method may comprise the step of transferring the entire balance of the cushion account to the manager in the event that the management of the managed fund is relinquished from the manager.

Advantageously, the transferring of the cushion account to the manager after the management of the managed fund ceased or the investor redeemed provides the manager with an incentive to manage the fund in a way so that the cushion account is not depleted by way of payout as a result of negative growth.

This aspect of the invention therefore also can improve any money management strategy that generates money due to systematic sources but suffers from short-term spikes in risk aversion, systemic shocks or idiosyncratic events. If widely adopted, the invention can thus also lead to the general public benefits from the improved stability of global financial system.

It will be appreciated that the features of the different aspects of the present invention may be combined with one another, as well as the features of the embodiments of the present invention where context allows. Further features and advantages of the present invention will be apparent in light of the description herein.

Embodiments of the present invention will now be described by way of example with reference to the accompanying drawings in which:

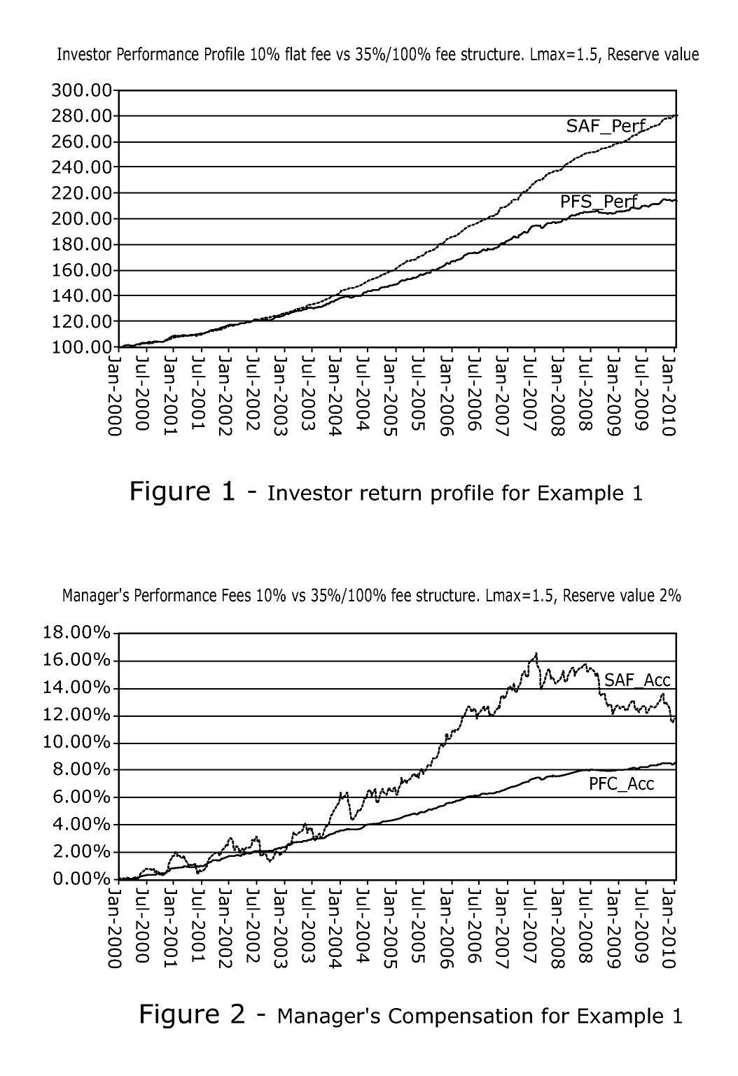

FIG. 1 is a graph showing the effect on investor return when an embodiment of the present invention is applied to a Fusion LIBOR+450 fund product;

FIG. 2 is a graph showing the effect on manager compensation when an embodiment of the present invention is applied to the Fusion LIBOR+450 fund product of FIG. 1;

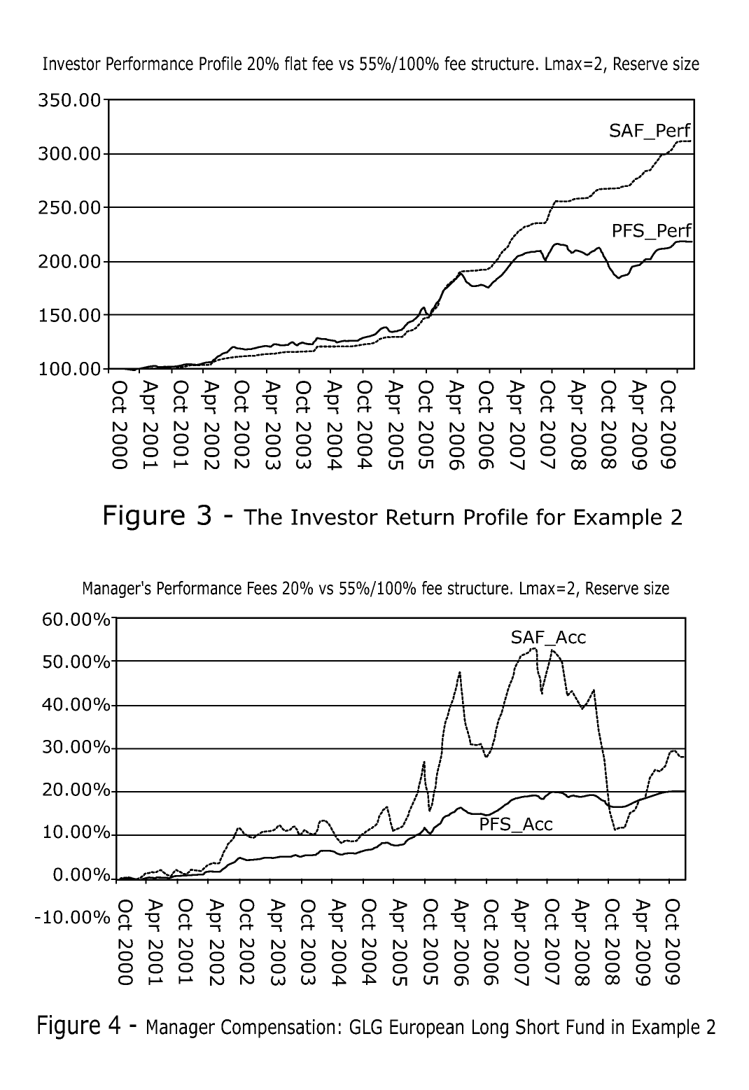

FIG. 3 is a graph showing the effect on investor return when an embodiment of the present invention is applied to a GLGELSA KY Equity fund product;

FIG. 4 is a graph showing the effect on manager compensation when an embodiment of the present invention is applied to the a GLGELSA KY Equity fund product of FIG. 3;

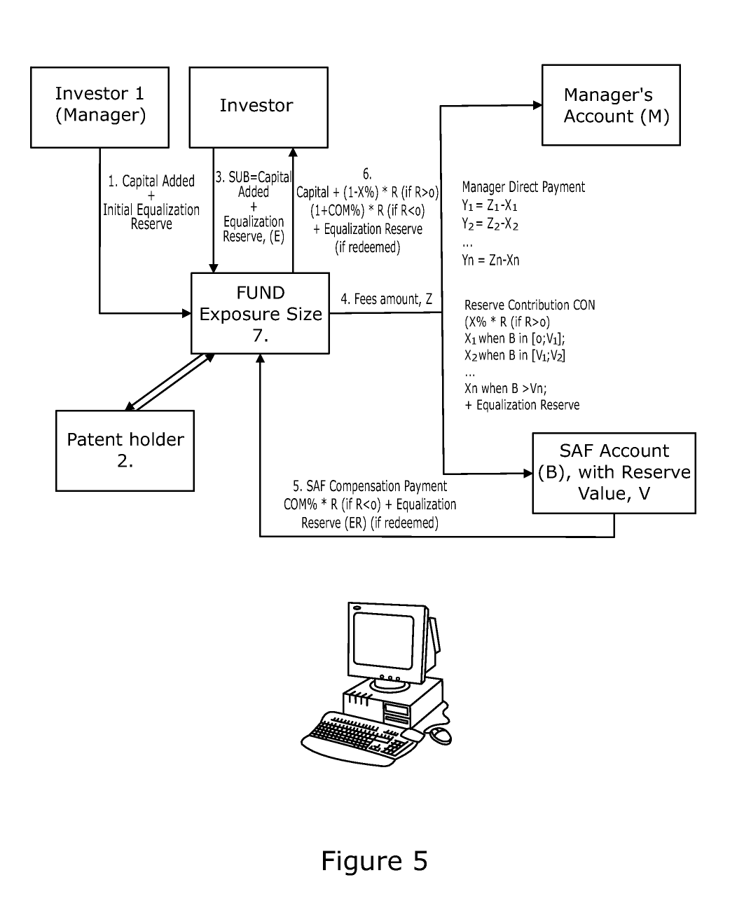

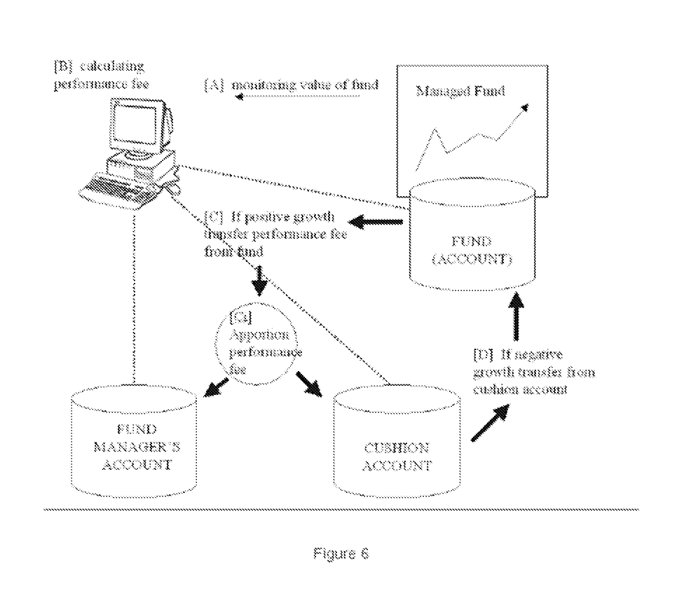

FIG. 5 is a schematic diagram showing an overview of an embodiment of the present invention, the interrelationship between its different components and areas of computerised calculations; and

FIG. 6 is an alternative schematic diagram showing an overview of an embodiment of the present invention, in particular, the computer system interaction with the different components of the present invention.

In the following detailed description of the embodiments, reference is made to the accompanying drawings that form a part hereof, and in which are shown by way of illustration, and not by way of limitation, specific embodiments in which the invention may be practiced. It is to be understood that other embodiments may be utilized and that logical, financial and other changes may be made without departing from the spirit and scope of the present invention.

### DETAILED DESCRIPTION OF THE EMBODIMENTS OF THE INVENTION

### Overview

According to a first embodiment of the invention, there is provided a method of controlling the management of a fund. The method of management, as will be described in further detail below, acts to align the interests of a manager and an investor. In addition, the invention provides a mechanism for the investor to seek compensation in the event that there is loss/negative growth of a managed fund thereby disconnecting the relationship of short-term fund performance volatility with performance fee generation and utilise the accumulated cash reserve to provide protection for the increased exposure in the related managed fund.

Broadly, this is achieved by tying managers' fees more closely to actual longer-term fund performance (negative or positive). This gives some comfort to investors that poor fund performance will be borne to some degree by the manager and not just the investor. Also it encourages good long-term performance, (i.e. a manager that engenders good fund performance is rewarded via performance fees).

More specifically, a proportion of the manager's performance fees are not released to the manager—instead being held in a separate account to act as a cushion against poor future performance. If the manager causes the fund to perform well over the long term then the stored fees are eventually released to the manager, in particular, when the investor exits the fund.

If the fund suffers a loss during a given time period, then the cushion account is used to compensate the loss of the fund (and by agreeing the portion of the performance fees paid to the cushion account the manager compensates the fund with some of performance fees retained in the cushion from previous positive fund performance periods). In this context, the separate cushion account acts like a buffer or cushion to dampen the downturn effects on the performance of the fund and to reduce the performance fee payments that would otherwise be collected by the manager due to volatility of the fund's performance. It can be seen that the downside volatility of the fund's performance is dampened as a result of the performance fees of the manager becoming more volatile.

This cushion mechanism is attractive to an investor as they are compensated out of the fund for poor fund manager performance. The mechanism is made more attractive to the fund a manger by offering a higher percentage of performance fees for good long-term performance (for example, performance fees of 50% rather than the standard 20%).

In that the performance fee is the way to compensate a manager for undertaking to provide downside protection to investors to the extent and proportionately to already accumulated performance fees.

The separate account therefore provides a mechanism to encourage good management/performance of the fund in the long term, and also provides a way for the investor to gain compensation where there has been a loss in the fund due to poor performance.

Therefore, the method of controlling the management of a fund may be thought of utilising a ‘Shock Absorber Fees’ with SAF Account into which ‘SAF Reserve Contribution are paid.

The SAF enable a number of different functions to be realised including:
i. An investor's asymmetric recourse against manager's fees
ii. Varied performance fees
iii. Dynamic Exposure
i. Investor's asymmetric recourse against manager's fees
   Using SAF, the manager provides asymmetric protection to the investor by accumulating his performance fees and giving the investor recourse against all accumulated SAF account balance for trading loss of a particular trading period (Loss).
ii. Varied performance fees
   The performance fee is agreed between the manager and the investor based on the size of the downside protection given to the investor by the manager (by giving resource against manager's fees). For example, where the investor and the manager agree that 100% of loss in Performance Period will be compensated from the manager's fees (via the cushion account), then the performance fees can be increased from typical 20% to reflect the amount of the downside compensated by the manager. The amount of the fees can be varied as the strategy's characteristics vary over time.
iii. Dynamic Exposure
   As the SAF balance changes, the exposure of the portfolio of the related managed fund is changed by an agreed parameters proportional to the balance of the SAF Account. This can be calculated in a number of ways (see formula for Exposure ‘L’ below in definitions section for an example).
   In case of increasing performance fees (and so the SAF account balance) the protected trading exposure is increased thus providing the investor the benefit of increasing upside without increase in risk. This utilises managers' fees in full for the benefit of the investor.

### Definitions

The variables described herein may be better understood with reference to the following definitions that represent a typical set for the present embodiment:

| | | |
|---|---|---|
| Downside Protection | N₁ when B in [0; V₁]; | % of negative performance (loss) over |
| | N₂ when B in [V₁; V₂]; | Performance Period to be compensated |
| | . . . | from the Reserve |
| | Nₙ when B > Vₙ; | |
| Equalization Reserve | E | a portion of the additional or subsequent |
| | | investment equal to the proportion of the |
| | | Reserve already accumulated in relation to |
| | | existing investment at time additional or |
| | | subsequent investment is made, and to be |
| | | credited to SAF Account |
| Manager Account | M (balance of Manager | bank account in the name of the manager |
| | Account) | where the Performance Fees Direct |
| | | Payment is paid into |
| Performance Fees | Z₁ when B in [0; V₁]; | agreed amount of performance fees |
| | Z₂ when B in [V₁; V₂]; | |
| | . . . | |
| | Zₙ when B > Vₙ; | |
| Manager Direct | Y₁ = Z₁ − X₁ | Amount of Performance Fees less the |
| Payment | Y₂ = Z₂ − X₂ | Reserve Contribution (or Adjusted Reserve |
| | . . . | Contribution) payable to the Manager direct |
| | Y_{n =} Zₙ − Xₙ | to the Manager Account |
| Performance Period | T | time step for calculating performance |
| | | (gains) |
| Reserve Value | V * NAVE | agreed threshold value of SAF account |
| | V₁, V₂, V₃, . . . Vₙ | |
| Reserve Contribution | X₁ when B in [0; V₁]; | agreed % of Performance Fees allocated to |
| | X₂ when B in [V₁; V₂]; | the SAF account |
| | . . . | |
| | Xₙ when B > Vₙ; | |
| SAF Account | B (balance of SAF | Bank account in the name of the manager |
| | Account) | with a charge in favour of the fund, balance |
| | | of which is contributed by: |
| | | (a) Reserve Contribution |
| | | (b) Equalization Reserve |
| Exposure | L_{1, . . .} Lₙ, | agreed parameters for adjusting the |
| | L_{n + 1} = Lₘₐₓ | exposure in the underlying trading portfolio |
| | | depending on the SAF Balance, B |

Formula for Exposure, L—a possible formula for calculation L, other more complicated non-linear variations are possible:

$$L = Θ ( B - {V}_{N + 1} ) {L}_{max} + {\sum }_{i = 0}^{N} Θ ( B - {V}_{i} ) Θ ( {V}_{i + 1} - B ) \{ \frac{{L}_{i + 1} - {L}_{i}}{{V}_{i + 1} - {V}_{i}} ( B - {V}_{i} ) + {L}_{i} \}$$

Before the details of the invention are described in detail it may be useful to consider the beneficial effects of the SAF as an embodiment of the invention:

### EXAMPLES OF THE EFFECT OF THE USE OF SAF

It will be noted that the invention can be applied to any Fund Product to improve the investment characteristics of a Fund Product. Below are merely examples of application of SAF on various Fund Products:
i. Fusion LIBOR+450 (FUAMLIB4 INDEX)
ii. GLG Long Short European Equity fund product (GLGELSA KY Equity) and the effects of such application on the investor and the manager.

As these examples will make evident, an investor benefits from better investment characteristics of the Fund Product. This is mainly diminished downside volatility, i.e. better capital protection of their investments as well as harmonic relationship with their managers (“same boat”). Furthermore, a fund manager benefits from potentially higher performance fees in the case of the funds positive performance and better stability of the assets under management (due to negative incentive for investors to redeem from performing managers). The greater compensation is justified by giving to investors an undertaking to compensate loss investor may suffer from manager's fees reserve.

### Example 1

### Fusion LIBOR+450 (FUAMLIB4 INDEX)

Investment Objective: Absolute return
Investment Strategy: Systematic and flexible cash management strategy based on quantitative analysis of FX and interest rate dynamics, overlaid with volatility forecasts
Target return LIBOR+450 bps, historic return 7.5% pa¹ with annual volatility around 2.5% Based on the backtest from January 2000 to December 2008
Subscription/Redemption: daily liquidity (on 2 days notice)
Customary Fee Structure: 10% performance fee², semi annual performance fees SAF parameters Calculated as flat fee, disregarding benchmark
Reserve Contribution, X₁=100%, X₂=100%
Reserve Value, V₀=0, V₁₌2%, V. 3%
Downside Protection, N=100%
Amount of Performance Fees, Z=35%
Exposure, L₀=L₁₌1, L₂₌Lₘₐₓ₌1, 5
Performance Period—weekly

The investor return profile results are shown in FIG. 1.

| Investment Characteristics | | |
|---|---|---|
| period January 2000-January 2010 | Simple | SAF |
| Annual Return | 7.5 | 10.25% |
| Annual Volatility | 2.1% | 1.52% |
| Annual Sharpe Ratio | 3.6 | 6.7 |
| Maximal monthly drawdown | −1.83% | 0% |

The application of SAF (on the parameters set out above) to the Fusion LIBOR+450 product materially improves the investment characteristics of the product by dramatically decreasing the volatility, noticeably improving Sharpe ratio, and diminishing the maximal drawdown.

The Manager's Compensation for Example 1 is shown in FIG. 2.

### Example 2

### GLG European Long Short Fund (GLGELSA KY Equity)

Investment objective: absolute return with a reduced market correlation
Investment Strategy: Long Short European Equity
Subscription monthly/Redemption monthly
Historic return 12% pa.
Customary Fee Structure: 20% performance fee, semi-annually
Maximal annual drawdown (pa) −18% SAF parameters
Reserve Contribution, X₁, X ₂=100%
Reserve Value, V₀=0, V₁=10%, V₁₌20%,
Downside Protection, N=100%
Amount of Performance Fees, Z=55%
Exposure, L₀=L₁=1, L₂=Lₘₐₓ=2
Performance Period—monthly

The Investor Return Profile for Example 2 is shown in FIG. 3

| Investment Characteristics | | |
|---|---|---|
| period October 2000-December 2009 | 20% | SAF (55%-100%) |
| Annual Return | 11.1% | 12.52% |
| Annual Volatility | 9.3% | 5.10% |
| Annual Sharpe Ratio | 1.2 | 2.5 |
| Largest annual drawdown | −15.53% | 0% |

The application of SAF (on the parameters set out above) to the GLG European Long Short Fund (GLGELSA KY Equity) materially improves the investment characteristics of the product by dramatically decreasing the volatility, noticeably improving Sharpe ratio, and diminishing the maximal drawdown.

FIG. 4 shows the Manager Compensation: GLG European Long Short Fund in Example 2

Differences with Regard to U.S. Pat. No. 7,624,059

As previously mentioned, U.S. Pat. No. 7,624,059 describes the Pre-Funded Accrual Account (PFAA) arrangement as an alternative to “simple” performance fee arrangement as well as a mechanism to decrease downside volatility of an investment.

PFAA is a fee structure where a loss in the investment vehicle is compensated from a specially set up account (PFAA) up to the amount of loss equal to accrued performance fees (typically 20%). The account is replenished from performance of the fund by first redirecting all gains into PFAA up to the point when the balance of the account reaches its previous high watermark after which the usual arrangement resumes. Here the high watermark is taken as the maximum value of PFAA of the previous periods.

PFAA clearly may be considered to have a certain degree of asymmetry in its performance fees which is, however, path-dependent rather than just depending on last balance, as in SAF. PFAA also envisages a use of “layered” performance fees, which depend on the absolute amount of profit on NAV date (ex, 20% on profits of 0-2% but 40% on moves above 2%) and a use of “Client Negotiated Reverse Accrual Basis”, when one wants to protect a loss larger than certain pre-defined amount. Both these uses are volatility-dependent and will provide different sorts of protection in different volatility environments.

Other interesting features of PFAA include Long Term Calculation Cycle with Fractional payouts when only a fraction (ex. 1/12) of the performance fee is paid on NAV dates while the balance is paid at the end of long cycle (ex. 5 years). This fractional payout arrangement is an analogue of SAF d distribution, which is defined by SAF balance rather than time.

However, the originally mentioned problems of PFAA remain.

First, after a drawdown of the underlying strategy, which covered by transfers from PFAA, investors have a strong incentive to redeem, since the subsequent first gains will be used to replenish PFAA, rather than to benefit the investors. Dealing with this issue might require to apply a lock on the investment capital, thus changing the liquidity characteristics of the investment.

Second, the protection available to the investor from PFAA is limited because below the high watermark the protection is financed by the investors performance, not the performance fees. The PFAA arrangement is asymmetric only when the PFAA is above the high watermark.

This dependence on high watermark poses also another problem: it introduces the path-dependence of the level of performance fees and PFAA balances and makes the analysis of optimal PFAA parameters much more complicated. Statistical analysis of PFAA requires modelling of the drawdown distribution and dynamics of the recovery of the drawdowns thus making the problem similar to the problem of pricing of barrier options. In contrast, SAF arrangement only requires the final value of the SAF balance and is in this respect similar to pricing of European options. It is well-known that the problem of pricing of barrier options is considerably more complex than the problem of pricing of European options and involves modelling of volatility of volatility and “tails” for the underlying strategy. Therefore, the SAF structure, in comparison with PFAA, is achieving both constant asymmetric schedule of performance fees and simplicity and stability of analysis of optimal SAF parameters.

Finally, the balance of the PFAA is only utilized to provide compensation of trading losses on a fixed size investment. There is no dynamic change in the exposure depending on the accumulated fees. Therefore, the investor cannot benefit from the cash that the manager is storing away.

### Specific Implementation

Referring to FIG. 5, there is shown the steps taken in the method of controlling the management of a fund in accordance with the first embodiment of the present invention. Note that the invention and SAF (as embodiment of the invention) can be applied on almost any Fund Product whether the investment is made through a fund or on a managed account basis. The present invention can be a computer-implemented method with processing and/or artificial intelligence units calculating the correct values (e.g. values to be transferred), parameter and variable amounts and databases employed to store the various accounts. The transfer of data between different accounts and computers can be implemented by secure messaging techniques.

FIG. 5 shows a specific implementation in Fund Product format

In brief, these steps are as follows:
0. Agreement on parameters if run in an umbrella fund or on a managed account (optional)
1. Initial Funding of SAF Account
2. Licence to the Fund to operate the scheme
3. Subscription
4. Fees Distribution
5. SAF Compensation Payment
6. Investor Return
7. Dynamic Exposure/Leverage

These steps will be elaborated on in more detail with continuing reference to FIG. 5:

Step 0—Parameters are Agreed

In case of a managed account or a fund with separate share class for each investor, the manager and the investor agree the following parameters (see above for detailed definitions):
i. Reserve Contribution, X₁, X ₂
ii. Reserve Value, V₁ . . . Vₙ
iii. Downside Protection, N₁ . . . Nₙ
iv. Amount of Performance Fees, Z₁ . . . Zₙ
v. Exposure, L₁ . . . Lₙ and Lₘₐₓ

Step 1—Licence to the Fund to Operate the Scheme

The Fund pays a fee to the License holder in return for the license to use the presently described method in operating the Fund.

Step 2—Initial Funding of SAF Account

The Investor 1 (manager) takes initial (a minimal) subscription to the fund (Fund) and undertakes to make an initial contribution into SAF Account.

Step 3—Subscription

Any subsequent (by the same investor) or additional (by the new investor) subscription will contribute into SAF account an Equalization Reserve.

The remaining amount of the subscription (Investment 2 less Equalization Reserve) is invested in the Fund (Capital Added).

When the investor redeems, the Equalisation Reserve (if any) is returned to the investor (rather than being released to the manager).

In relation to subsequent investment, the redemption proceeds for each investor are calculated on “the last in, last out” principle to ensure that the investor gets the most benefit from “most full” SAF Account.

Step 4—Fees Distribution

At the end of the Performance Period the performance fees are split

An X portion of the performance fees for a Performance Period, the Reserve Contribution is paid at the end of the Performance Period into a SAF Account in the name of the manager with a charge in favour of the fund (rather than being paid in full directly to the manager).

The Reserve Contribution is paid into the SAF Account until SAF Account balance reaches Reserve Value, V).

Step 5—SAF Compensation Payment

In case of negative performance in any Performance Period (Loss), a certain agreed amount of Loss (n factor, Downside Protection is compensated from the SAF account (to the extent there are sufficient funds available in SAF account) to the fund (SAF Compensation Payment).

Step 6—Investor Return

When investor redeems from the fund investment, any positive balance from the SAF account (less Equalization Reserve, if any) is released to the manager.

Step 7—Dynamic Exposure

At any time during the life of the Fund, as the SAF balance changes, the exposure of the portfolio of the related trading fund (Exposure, L) is changing according to an agreed parameter L, subject to Maximum Exposure. An investor benefits from the increasing potential exposure where the SAF balance grows. Functional dependence of the exposure can be generalized from the simplest piece-wise linear function considered here to more general functional form without affecting the main features of the invention.

FIG. 6 shows a very general overview of a typical computer system interacting with the different general components of embodiments of the present invention. In particular, and as denoted by the dashed lines, the computer system may be interfaced with a fund account, a fund manager's account and a cushion account as already described. The computer system is thus able to carry out the steps of the present invention such as monitoring fund value and transferring funds between accounts.

### Alternatives

As alluded to earlier, the invention can be applied to the management of different types of resources, for example energy resources.

Where the supply of electrical energy is subject to uncontrollable factors and so is unreliable or volatile in nature, the same principles can be applied as will now be briefly discussed as an alternative to the present invention, with the following substitutions being made:
Instead of a Fund, an electrical energy generating facility is provided.
Instead of a Fund Manager, an electrical energy manager is provided. In will be understood the manager may be implemented in the form of an artificial intelligence program.
Instead of an Investor, an electrical energy generating facility owner is provided.
Instead of a Fund Manager account, an ancillary energy distribution system is provided.
Instead of a SAF account, an electrical energy store is provided.

In this example, the electrical energy generating facility is able to generate electrical energy via a number of different mediums—for example through wind farms, hydroelectric facilities and the like. The electrical energy produced is used to power a set of primary loads. The primary loads are those that are the most important for the electrical energy facility owner to power (for example, hospitals, police stations etc). One aim is for the electrical energy produced to be increased over time to meet an increasing demand from the primary loads (e.g. additional hospitals are opened). This may be considered to be analogous with the need for Fund growth in the previous example.

The electrical energy facility owner employs an electrical energy manager to manage the facility, with the objective of at least powering the set of primary loads. In addition, a further aim is to increase the amount of electrical energy beyond the minimum required to generate a surplus. Compensation for management comes in the form of some of the total energy generated to be diverted to the manager's own ancillary energy distribution system (for example, powering a set of secondary loads, such as residential or commercial buildings)—c.f. a basic management fee in the previous example. As a reward for good energy management (e.g. generating a large surplus of energy), a larger proportion of the total energy, e.g. a proportion of the surplus energy, can be diverted to the manager's own ancillary energy distribution system—c.f. taking a ‘slice of the profits’ in the previous example. As the generation of electricity can be volatile over the short term, the assessment of total energy generation is made over a given performance period.

With the set up in its current form, the manager may be tempted to manage the energy in a risky manner, for example, investing in sources that are capable of generating large amounts of electricity, but are highly subject to uncontrollable forces (e.g. wind farms). Thus, in the times when it is windy, the electrical energy generation is excellent. There is more than enough energy to power the primary loads and the manager receives a large reward by way of diversion of a large amount of electrical energy to the manager's ancillary energy distribution facility for powering the secondary loads. In times where there is no wind, there may not be enough energy to power even the primary loads. This will not overly concern the manager, but is a major problem for the electrical energy generating facility owner.

In an attempt to align the interests of the electrical energy generating facility owner and the manager, an electrical energy store is provided. At the start of management, a proportion of the surplus energy generated is diverted to this store that is built up over time. In the event that there is a downturn in the amount of electrical energy provided, the store can be used to power the essential primary sources. If the store fills to a predetermined level (c.f. Reserve Value, V in the previous example) then the amount of surplus energy being diverted to the store can be tailed off, instead being diverted to the manager's ancillary energy distribution facility. Therefore, it is in the interests of the manager to manage the electrical energy generating facility in a manner that will provide a consistent (and surplus) amount of power so as to keep the store topped up and so diverting a larger proportion of the surplus to the managers own distribution facility. In the event that there is a shortfall, then the owner of the energy generating facility has an asymmetric recourse via using the surplus energy in the store.

It will be appreciated that a person skilled in the art will be able to apply further concepts discussed in the first example to the second example, each pertaining to the advantageous management of resources.

It will also be appreciated that a person skilled in the art will be able to apply all the concepts discussed herein to the advantageous management of a number of other types of resources.

The forms of invention shown and described herein are to be considered only as illustrative. It would be apparent to those skilled in the art that modifications may be made therein without departing from the spirit of the invention or the scope of the appended claims.

1. A method of managing resources in the form of a fund that is managed by a fund manager, the method comprising:
monitoring the value of the fund, using a computer system, over a time period;
calculating, using the computer system, a performance fee that is due to the fund manager for managing the fund for said time period;
adding, when the value of the fund increases over said time period, a first portion of the performance fee to a fund manager's account, and a second portion of the performance fee to a cushion account, said adding being performed by the computer system;
subtracting, when the value of the managed fund decreases over said time period, a compensation fee from the cushion account to compensate for at least some of the decreased value of the managed fund, said subtracting being performed by the computer system; and
repeating said steps of monitoring, calculating, adding and subtracting over multiple time periods to maximize the stabilizing potential of the cushion account and to reduce the volatility of the fund value; wherein consecutive time periods of increasing fund value increases the amount added to the cushion account asymmetrically to the amount added to the fund manager's account.

2. The method of claim 1, wherein the cushion account and the fund manager's account are separate from one another.

3. The method of claim 1, further comprising the step of setting at least one threshold value against which the value of the fund is compared, the difference between the threshold value and the fund value being used to control the calculation of the size of the performance fee.

4. The method of claim 2, wherein the difference between the threshold value and the fund value is used to control at least one of the sizes of the first and second portions.

5. The method of claim 1, further comprising the step of setting at least one predetermined value against which the value of the cushion account is compared, the difference between the predetermined value and the cushion account value being used to control the calculation of at least one of the size of the performance fee, the first portion and the second portion.

6. The method of claim 1, further comprising the step of defining at least one parameter for controlling the computer system.

7. The method of claim 6, wherein said at least one parameter is for calculating the performance fee that is due to the fund manager for managing the managed fund.

8. The method of claim 6, wherein said at least one parameter is for determining the size of at least one of the first and second portions of the performance fee.

9. The method of claim 6, wherein said at least one parameter comprises at least one of: Downside Protection, Equalization Reserve, Manager Account, Performance Fees, Manager Direct Payment, Performance Period, Reserve Value, Reserve Contribution, SAF Account and Exposure.

10. The method of claim 6, further comprising authorizing an agreement between a fund stakeholder and the fund manager, the agreement including the definition of said at least one parameter.

11. The method of claim 1, further comprising the steps of:
communicating, using a computer system, a set of parameters between a fund stakeholder and a fund manager;
receiving agreement from the fund stakeholder and the fund manager on the set of parameters, the agreement being authenticated by the computer system;
receiving funds from the fund stakeholder into the fund to be managed by the fund manager; and
enabling control, using the computer system, of the fund to the fund manager.

12. The method of claim 1, further comprising the step of controlling the exposure of the managed fund in response to the amount available within the cushion account.

13. The method of claim 12, wherein controlling the exposure comprises controlling the exposure dynamically in proportion to the amount available within the cushion account.

14. The method of claim 12, wherein controlling the exposure comprises authorising the fund manager to change the exposure of the managed fund.

15. The method of claim 1, further comprising the step of receiving an initial contribution to the cushion account.

16. The method of claim 1, wherein the adding step comprises varying the amount of at least one of the first and second portion of the performance fees in accordance with the value of the cushion account.

17. The method of claim 1, further comprising the step of transferring at least a portion of the value of the cushion account to the fund manager's account in the event that the management of the managed fund is relinquished from the fund manager, thus incentivizing the fund manager to manage the fund in a way maximising cushion account growth.

18. A method of managing resources comprising:
communicating, using a computer system, a set of parameters between a resource provider and a resource manager;
receiving agreement from the resource provider and resource manager on the set of parameters, authenticated by the computer system;
receiving resources from the resource provider into a resource reserve to be managed by the resource manager;
enabling control, using the computer system, of the resource reserve to the resource manager;
apportioning, using a computer system, additional resources generated from the resource reserve after a period of management by the resource manager between the resource manager, the resource reserve and a resource store separate from the resource reserve; and
supplementing, after subsequent periods of management by the resource manager, the resource reserve from the separate resource store if additional resources are not sufficiently generated.

19. The method of claim 18, wherein the apportioning of additional resources is modified once the resources in the separate resource store have reached a threshold limit.

20. A method of stabilizing the value of an resource that is managed by an resource manager on the behalf of a stakeholder, the method comprising:
monitoring the value of the resource, using a computer system, over a time period;
calculating, using the computer system, a performance fee that is due to the resource manager for managing the resource for said time period;
adding, when the value of the resource increases over said time period, a first portion of the performance fee to an resource manager's account, and a second portion of the performance fee to a cushion account, said adding being performed by the computer system;
subtracting, when the value of the managed resource decreases over said time period, a compensation fee from the cushion account to compensate the stakeholder for at least some of the decreased value of the managed resource, said subtracting being performed by the computer system;
repeating said steps of monitoring, calculating, adding and subtracting over multiple time periods to maximize the stabilizing potential of the cushion account and to reduce the volatility of the resource value; wherein consecutive time periods of increasing resource value increases the amount added to the cushion account asymmetrically to the amount added to an resource manager's account.
